(19) United States
(12) Patent Application Publication
(10) Pub. No.: US 2009/0307034 A1
(43) Pub. Date: Dec. 10, 2009

(54) ENERGY INFORMATION MANAGEMENT SYSTEM

(75) Inventors: John M. Duff, Carmel, IN (US); Michael R. Lavelle, Indianapolis, IN (US)

Correspondence Address: BARNES & THORNBURG LLP, 11 SOUTH MERIDIAN, INDIANAPOLIS, IN, 46204, US

(73) Assignee: ENthEnergy, LLC, Carmel, IN (US)

(21) Appl. No.: 12/479,077

(22) Filed: Jun. 5, 2009

Related U.S. Application Data
(60) Provisional application No. 61/059,373, filed on Jun. 6, 2008.

(51) Int. Cl. G06Q 10/00; G06F 17/30; G06F 3/048; G06F 1/28; G06F 1/32; G06F 15/00

(52) U.S. Cl. 705/7; 707/104.1; 715/772; 702/188; 700/291; 702/64

(57) ABSTRACT

An energy information management system and a computer-implemented method of managing energy information are disclosed. The computer-implemented method may include receiving energy use data based upon the energy consumption of one or more facilities, associating the energy use data with one or more facility types based upon characteristics of the one or more facilities to which the energy use data is related, and storing the energy use data in a database. Each facility type may be determined based upon at least one of an owner, location, size, age, use, operating schedule, lighting, water use, and heating, ventilation, and air conditioning equipment of the facility to which the energy use data is related. The energy information management system may include one or more sources of energy use data which generate data signals, a server, and a browser-enabled user device.

### CROSS REFERENCE TO RELATED APPLICATIONS

This application claims priority under 35 U.S.C. § 119(e) to U.S. Provisional Patent Application Ser. No. 61/059,373 entitled “Energy Information Management System,” filed on Jun. 6, 2008, which is hereby expressly incorporated by reference herein. Cross-reference is made to co-pending U.S. Utility patent application Ser. No. ______ entitled “Energy Management System” by Michael R. Lavelle and John M. Duff (Attorney Docket No. 37246-208882), which is assigned to the same assignee as the present application, filed concurrently herewith, and hereby expressly incorporated by reference herein.

### BACKGROUND OF THE INVENTION

The present disclosure generally relates to the management of energy information. More particularly, the present disclosure relates to energy information management systems and computer-implemented methods of managing energy information.

### SUMMARY OF THE INVENTION

The present application discloses one or more of the features recited in the appended claims and/or the following features which, alone or in any combination, may comprise patentable subject matter:

According to one aspect, a computer-implemented method of managing energy information comprises receiving energy use data based upon the energy consumption of one or more facilities, associating the energy use data with one or more facility types based upon characteristics of the one or more facilities to which the energy use data is related, and storing the energy use data in a database. In some embodiments, receiving energy use data may include receiving utility company information which represents the energy consumption of a facility over approximately monthly periods. Receiving energy use data may also include receiving signals from a utility meter or shadow meter which periodically measures and records an interval value of the energy consumption of a facility. Each facility type may be determined based upon at least one of an owner, location, size, age, use, operating schedule, lighting, water use, and heating, ventilation, and air conditioning equipment of the facility to which the energy use data is related.

In some embodiments, the computer-implemented method of managing energy information may further comprise validating the energy use data by comparing values of the energy use data to one or more expected ranges. The expected ranges may be based upon at least one of (i) a facility type associated with the energy use data and (ii) previously stored energy use data in the database. The method may include analyzing the energy use data by grouping energy use data associated with a particular facility type or associated with multiple facility types which share a common characteristic. The method may also include analyzing the energy use data by comparing a selected portion of energy use data related to a particular facility to a base year of energy use data related to the particular facility. In some embodiments, the selected portion of energy use data may include at least the most recent month of energy use data. The selected portion of energy use data may be the most recent twelve months of energy use data and the base year of energy use data may be the twelve months of energy use data immediately preceding the most recent twelve months of energy use data. Analyzing the energy use data may include comparing an energy consumption cost of the selected portion of energy use data to an energy consumption cost of the base year of energy use data.

In still other embodiments, the computer-implemented method of managing energy information may further comprise applying a linear regression model which uses one or more energy-sensitive variables to at least one of the selected portion of energy use data and the base year of energy use data. The one or more energy-sensitive variables may include weather conditions, occupancy, and/or production level. The method may include analyzing the energy use data to determine the need for an energy use reduction for a particular facility, and sending an alert message to a user if the energy use reduction is needed. The method may also include generating signals which cause either a portion of the energy use data or information representing an analysis of the energy use data to be displayed to a user.

According to another aspect, a computer-readable medium may embody a program of instructions executable by a processor to perform process steps for managing energy information. This program of instructions, executable by the processor, may comprise receiving energy use data based upon the energy consumption of one or more facilities, associating the energy use data with one or more facility types based upon characteristics of the one or more facilities to which the energy use data is related, and storing the energy use data in a database. In some embodiments, receiving energy use data may include receiving utility company information which represents the energy consumption of a facility over approximately monthly periods. The step of receiving energy use data may also include receiving signals from a utility meter or shadow meter which periodically measures and records an interval value of the energy consumption of a facility. Each facility type may be determined based upon at least one of an owner, location, size, age, use, operating schedule, lighting, water use, and heating, ventilation, and air conditioning equipment of the facility to which the energy use data is related.

In some embodiments, the computer-readable medium may embody a program of instructions which further includes validating the energy use data by comparing values of the energy use data to one or more expected ranges. The expected ranges may be based upon at least one of (i) a facility type associated with the energy use data and (ii) previously stored energy use data in the database. The program of instructions may include analyzing the energy use data by grouping energy use data associated with a particular facility type or associated with multiple facility types which share a common characteristic. The program of instructions may also include analyzing the energy use data by comparing a selected portion of energy use data related to a particular facility to a base year of energy use data related to the particular facility. In some embodiments, the selected portion of energy use data may include at least the most recent month of energy use data. The selected portion of energy use data may be the most recent twelve months of energy use data and the base year of energy use data may be the twelve months of energy use data immediately preceding the most recent twelve months of energy use data. Analyzing the energy use data may include comparing an energy consumption cost of the selected portion of energy use data to an energy consumption cost of the base year of energy use data.

In still other embodiments, the computer-readable medium may embody a program of instructions which further includes applying a linear regression model which uses one or more energy-sensitive variables to at least one of the selected portion of energy use data and the base year of energy use data. The one or more energy-sensitive variables may include weather conditions, occupancy, and/or production level. The program of instructions may include analyzing the energy use data to determine the need for an energy use reduction for a particular facility, and sending an alert message to a user if the energy use reduction is needed. The program of instructions may also include generating signals which cause either a portion of the energy use data or information representing an analysis of the energy use data to be displayed to a user.

According to yet another aspect, an energy information management system may comprise one or more sources of energy use data which generate data signals based upon the energy consumption of one or more facilities and a server which is configured to: (i) receive the data signals from the one or more sources of energy use data, (ii) derive energy use data from the data signals, (iii) associate the energy use data with one or more facility types based upon characteristics of the one or more facilities to which the energy use data is related; and (iv) store the energy use data in a database. In some embodiments, at least one of the sources of energy use data may be a utility company network which allows access to information regarding the energy consumption of a facility over approximately monthly periods. In other embodiments, at least one of the sources of energy use data may be a utility meter or shadow meter which periodically measures and records an interval value of the energy consumption of a facility. The server may determine which one or more facility types to associate with the energy data based upon at least one of an owner, location, size, age, use, operating schedule, lighting, water use, and heating, ventilation, and air conditioning equipment of the facility to which the energy use data is related.

In some embodiments, the server of the energy information management system may be further configured to validate the energy use data by comparing values of the energy use data to one or more expected ranges. The expected ranges may be based upon at least one of (i) a facility type associated with the energy use data and (ii) previously stored energy use data in the database. The server may be further configured to analyze the energy use data by grouping energy use data associated with a particular facility type or associated with multiple facility types which share a common characteristic. The server may also be further configured to analyze the energy use data by comparing a selected portion of energy use data related to a particular facility to a base year of energy use data related to the particular facility.

In some embodiments, the selected portion of energy use data may include at least the most recent month of energy use data. The selected portion of energy use data may be the most recent twelve months of energy use data and the base year of energy use data may be the twelve months of energy use data immediately preceding the most recent twelve months of energy use data. The server may be configured to compare an energy consumption cost of the selected portion of energy use data to an energy consumption cost of the base year of energy use data. The server may also be configured to apply a linear regression model which uses one or more energy-sensitive variables to at least one of the selected portion of energy use data and the base year of energy use data. The one or more energy-sensitive variables may include weather conditions, occupancy, and/or production level.

In still other embodiments, the energy information management system may include a browser-enabled user device. The browser-enabled user device may be a wireless device. The server of the energy information management system may be configured to generate output signals which cause either a portion of the energy use data or information representing an analysis of the energy use data to be displayed on the browser-enabled user device. In some embodiments, the server may be configured to analyze the energy use data to determine the need for an energy use reduction for a particular facility and to send an alert message to the browser-enabled user device if the energy use reduction is needed.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 illustrates a general process by which specific inputs are processed by the Energy Information Management System (EIMS) to produce specific outputs; and

FIG. 2 illustrates an embodiment of the processes which may contribute to the EIMS.

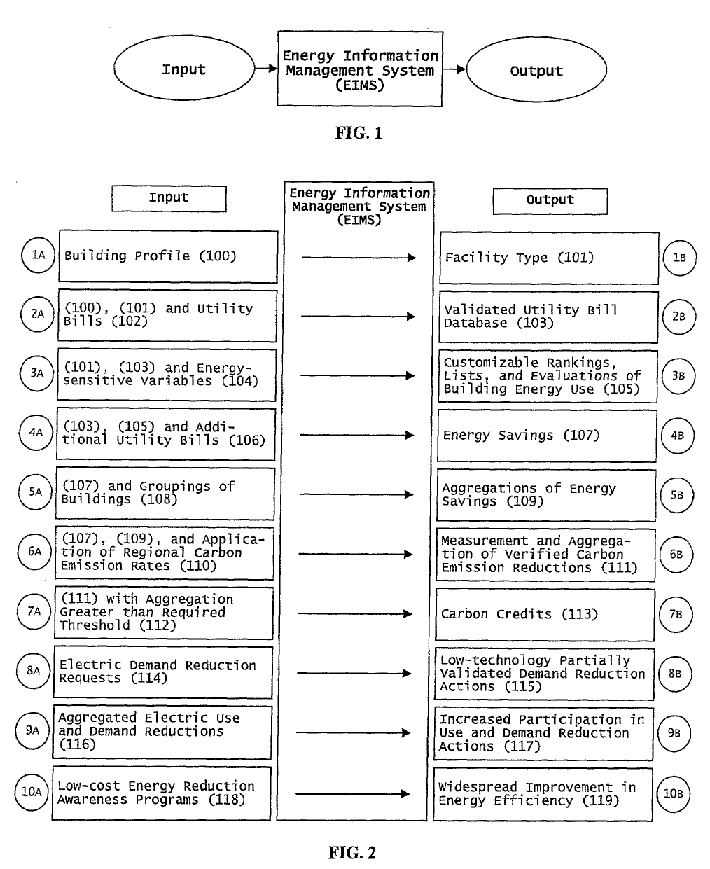

In these figures, the alpha-numeric characters in circles indicate processes that are described herein, starting at the process number ending in the letter “A” and ending with the same process number ending in the letter “B.” The numbers in parentheses indicate labels for items that are described herein.

### DETAILED DESCRIPTION OF THE DRAWINGS

In the following detailed description, numerous specific details are described in order to provide a thorough understanding of the invention. The illustrative processes are not necessarily described in the order in which they are accomplished: some may be accomplished in parallel or omitted altogether in certain embodiments.

In illustrative Process 1, Building Profile 100 information regarding a building owner, location, size, age, use, operating schedule, lighting, water use, heating, ventilation, and air conditioning equipment, and other factors necessary to classify a particular building or facility are entered into the Energy Information Management System (EIMS) for the purpose of assigning the particular building a Facility Type 101. Each Facility Type 101 is a building category that allows the creation of useful associations for the purpose of enhancing building operation, improving energy efficiency, informing interested parties regarding all manners of energy information, and to allow comparisons of a particular building to those that are similar. These Facility Types 101 enable effective groupings of buildings and analysis of associated energy use data within the EIMS. Since there are potentially hundreds of Facility Types 101 that can be created, one of the characteristics of the EIMS is to evaluate the effectiveness of each Facility Type 101 so as to create the smallest number of effective groupings as reasonably practicable.

In illustrative Process 2, energy use data is received by or input to the EIMS from one of more sources. Generally, this energy use data will be based upon the energy consumption of one or more facilities or buildings. As used in this disclosure, “based upon” refers to an item which is affected by, but not solely dependent on, some other condition. In some embodiments, the energy use data may derive from Utility Bills 102, consisting of a utility company's available billing information, typically provided on an approximately monthly basis. Information from the Utility Bills 102, such as the electric and heating fuel costs and quantities (kWh, therms, gallons of oil, etceteras), may be entered for the purposes of creating a Validated Utility Bill Database 103 for a particular building for use within the EIMS. In some embodiments, the Information found in Utility Bills 102 may be obtained from a utility company electronically via a computer network, such as the Internet. In other embodiments, the energy use data may also derive directly from a “continuous” source of energy information, such as a utility meter which periodically measures and records an interval value of the energy consumption of the facility. Alternatively, a shadow meter may be installed if information is not directly available from the utility meter. Thus, Utility Bills 102 and/or interval readings from a utility meter or shadow meter may be stored in the database to create “months of energy use data” for a facility.

The EIMS is also capable of validating the energy use data supplied to the system. The validation process may perform numerous checks, depending on source of the energy use data, such as the bill type. For instance, the EIMS may utilize Building Profile 100, Facility Type 101, and previously entered Utility Bills 102 to determine the reasonableness of the received billing information. The EIMS may compare the values of the energy use data to expected ranges based upon available information. The resulting Validated Utility Bill Database 103 is used for information regarding that particular building or facility and is also anonymously aggregated by Facility Type 101 and other useful groupings to enable the evaluation and dissemination of building energy use information for use by the EIMS and its users.

In illustrative Process 3, the Facility Type 101 and Validated Utility Bill Database 103 information may be combined with Energy-sensitive Variables 104 by the EIMS and its users to create Customizable Rankings, Lists, and Evaluations of Building Energy Use 105. Among the custom groupings included are (1) by facility type, (2) by location, (3) by owner, (4) by owner's organization type, (5) by facility use, (6) by facility size, (7) by building age, (8) by building height, and (9) by any combination of the preceding eight groupings, as well as groupings that can be customized to meet the needs of specific users. When applicable, linear regression techniques can be applied using energy-sensitive variables to create normalized energy use information so as to allow more accurate comparisons to be made, both against other buildings' energy use and against the building's past energy use.

The EIMS can also determine changes in energy use over time and measure Energy Savings 107 in a third-party verifiable manner, as shown in illustrative Process 4. By way of example, the Validated Utility Bill Database 103 information may be processed with Evaluations of Building Energy Use 105 and Additional Utility Bills 106, entered over time, typically on a monthly basis, to calculate Energy Savings 107. The EIMS may determine Energy Savings 107 in a manner that conforms as closely as practicable to the International Performance Measurement and Verification Protocol (IPMVP) and the American Society of Heating, Refrigeration, Air-Conditioning Engineers (ASHRAE) Guideline 14, Measurement of Energy and Demand Savings. The EIMS is able to export the information used in the Energy Savings 107 calculations for the purpose of third-party verification and for other information management purposes. The EIMS is also capable of calculating savings using one or more linear regressions of energy use using energy-sensitive independent variables, such as weather conditions, occupancy, and/or production levels. Illustratively, the following two methods might be used by the EIMS:

(1) “Actual Energy Savings” based on the available, applicable energy-sensitive variables that existed during a specified time period regarded as the “base year” and the current values of those variables that are contemporaneous to the energy use data applied to a linear regression model of the base year so as to calculate the difference between current energy use and the energy use that would have been expected to be used if current year variables are applied to “base year” building use and conditions; and

(2) “Normalized Energy Savings” based on the applicable normal values of the variables as averaged over a number of years, such as 20-year average weather, and applying linear regression techniques to normalize both the “base year” and current year energy use data so as to calculate the savings that would be expected during “normal” conditions.

In illustrative Process 5, Groupings of Buildings 108 may be created for the purpose of combining their Energy Savings 107 to form any number of Aggregations of Energy Savings 109 to enable presentation of these aggregates within the EIMS. These aggregates can be formed in a manner similar to the Customizable Rankings, Lists, and Evaluations of Building Energy Use 105, describe above, and are used by the EIMS and its users to measure the Energy Savings of the group(s) specified.

Illustrative Process 6 demonstrates how Regional Carbon Emission Rates 110 from utilities, as reported by the Environmental Protection Agency (EPA), that supply energy to the building(s) in question are applied to the Energy Savings 107 and Aggregations of Savings 109 for the purpose of Measurement and Aggregation of Verified Carbon Emission Reductions 111. The aggregation can be accomplished in many different manners, such as those used in Processes 3 and 5. Since the process has two authoritative inputs, Validated Utility Bills 103 and Regional Carbon Emission Rates 110 from utilities, as reported by the EPA, the EIMS provides a reliable measurement of carbon emission reductions.

When the Aggregation of Verified Carbon Emission Reductions 111 exceeds the Required Threshold 112, as determined by carbon credit current market conditions, Carbon Credits 113 may be obtained, as shown in Process 7. These Carbon Credits 113 may be used by the EIMS, its customers, sponsors, partners, and other designated parties as applicable and approved by the owners of the buildings that contributed to the carbon reductions. On their own, most buildings cannot save enough carbon emissions to reach the threshold amount to enable carbon credit trading. By aggregating these small reductions into one that exceeds the threshold, the EIMS enables these credits to be traded.

In illustrative Process 8, the EIMS is capable of analyzing stored energy use data to determine the need for energy use reduction at a particular facility. Electric Demand Reduction Requests 114 are processed by the EIMS and enable Low-technology, Partially Validated Demand Reduction Actions 115. Many systems implement demand reduction actions by applying some installed technology, such as distributed electric generation, residential air-conditioning compressor shutoff devices, and direct linkage to Building Automation Systems. In contrast, the EIMS sends suitable messages for building operators to take actions based on expected or current demand reduction requirements, for instance, to counteract the effects of losing electric generation or distribution capacity, weather-related high demand problems, or other circumstances that make reducing demand or energy use desirable. The building operators are able to respond to these request messages indicating the actions taken or to be taken. A sampling of the resulting energy use reductions based on actual metering enables the EIMS to partially validate the energy use reduction results.

Illustrative Process 9 shows how Aggregated Electric Use and Demand Reductions 116 may be used by the EIMS to produce Increased Participation in Use and Demand Reduction Actions 117. The use and demand reductions of a single building may not seem important to the people involved in operating the building, but when added together with numerous other buildings, the use and demand reductions become significant. The EIMS, by making the participants aware of the combined effects of their actions, encourages increased participation in the activities that lead to reduced energy use and demand.

In illustrative Process 10, Low-cost Energy Reduction Awareness Programs 118 are implemented by the EIMS to motivate Widespread Improvement in Energy Efficiency 119. As part of any good management system, providing appropriate, effective, and timely information to the building users and operators is important in initiating and maintaining effective energy reduction efforts. It is the ability to provide this information in a low-cost manner that enables the EIMS to be applied to a much larger population and range of buildings than previously devised systems.

The illustrative processes described above may be implemented in the EIMS by a server which is configured to receive data signals from one or more energy use data sources, such as those discussed above with regard to Process 2. In some embodiments, this server may include a computer-readable medium which embodies a program of instructions executable by a processor of the server to perform the illustrative processes described above. The EIMS may also include a user device which is capable of receiving messages and output signals to display information to a user. In some embodiments, the user device may be a browser-enabled and/or a wireless device. Although certain illustrative embodiments have been described in detail above, variations and modifications exist within the scope and spirit of this disclosure as described and as defined in the following claims.

1. A computer-implemented method of managing energy information, the method comprising:
receiving energy use data based upon the energy consumption of one or more facilities;
associating the energy use data with one or more facility types based upon characteristics of the one or more facilities to which the energy use data is related; and
storing the energy use data in a database.

2. The method of claim 1, wherein receiving energy use data comprises receiving utility company information which represents the energy consumption of a facility over approximately monthly periods.

3. The method of claim 1, wherein receiving energy use data comprises receiving signals from a utility meter or shadow meter which periodically measures and records an interval value of the energy consumption of a facility.

4. The method of claim 1, wherein each facility type is determined based upon at least one of an owner, location, size, age, use, operating schedule, lighting, water use, and heating, ventilation, and air conditioning equipment of the facility to which the energy use data is related.

5. The method of claim 1, further comprising validating the energy use data by comparing values of the energy use data to one or more expected ranges, wherein the expected ranges are based upon at least one of (i) a facility type associated with the energy use data and (ii) previously stored energy use data in the database.

6. The method of claim 1, further comprising analyzing the energy use data by grouping energy use data associated with a particular facility type or associated with multiple facility types which share a common characteristic.

7. The method of claim 1, further comprising analyzing the energy use data by comparing a selected portion of energy use data related to a particular facility to a base year of energy use data related to the particular facility.

8. The method of claim 7, wherein the selected portion of energy use data includes at least the most recent month of energy use data.

9. The method of claim 8, wherein the selected portion of energy use data is the most recent twelve months of energy use data and the base year of energy use data is the twelve months of energy use data immediately preceding the most recent twelve months of energy use data.

10. The method of claim 8, wherein analyzing the energy use data comprises comparing an energy consumption cost of the selected portion of energy use data to an energy consumption cost of the base year of energy use data.

11. The method of claim 7, wherein analyzing the energy use data further comprises applying a linear regression model which uses one or more energy-sensitive variables to at least one of the selected portion of energy use data and the base year of energy use data.

12. The method of claim 11, wherein the one or more energy-sensitive variables comprise weather conditions, occupancy, production level, or a combination thereof.

13. The method of claim 1, further comprising:
analyzing the energy use data to determine the need for an energy use reduction for a particular facility; and
sending an alert message to a user if the energy use reduction is needed.

14. The method of claim 1, further comprising generating signals which cause either a portion of the energy use data or information representing an analysis of the energy use data to be displayed to a user.

15. A computer-readable medium embodying a program of instructions executable by a processor to perform process steps for managing energy information, said process steps comprising:
receiving energy use data based upon the energy consumption of one or more facilities;
associating the energy use data with one or more facility types based upon characteristics of the one or more facilities to which the energy use data is related; and
storing the energy use data in a database.

16. The computer-readable medium of claim 15, wherein receiving energy use data comprises receiving utility company information which represents the energy consumption of a facility over approximately monthly periods.

17. The computer-readable medium of claim 15, wherein receiving energy use data comprises receiving signals from a utility meter or shadow meter which periodically measures and records an interval value of the energy consumption of a facility.

18. The computer-readable medium of claim 15, wherein each facility type is determined based upon at least one of an owner, location, size, age, use, operating schedule, lighting, water use, and heating, ventilation, and air conditioning equipment of the facility to which the energy use data is related.

19. The computer-readable medium of claim 15, further comprising instructions executable by a processor to perform the process step of validating the energy use data by comparing values of the energy use data to one or more expected ranges, wherein the expected ranges are based upon at least one of (i) a facility type associated with the energy use data and (ii) previously stored energy use data in the database.

20. The computer-readable medium of claim 15, further comprising instructions executable by a processor to perform the process step of analyzing the energy use data by grouping energy use data associated with a particular facility type or associated with multiple facility types which share a common characteristic.

21. The computer-readable medium of claim 15, further comprising instructions executable by a processor to perform the process step of analyzing the energy use data by comparing a selected portion of energy use data related to a particular facility to a base year of energy use data related to the particular facility.

22. The computer-readable medium of claim 21, wherein the selected portion of energy use data includes at least the most recent month of energy use data.

23. The computer-readable medium of claim 22, wherein the selected portion of energy use data is the most recent twelve months of energy use data and the base year of energy use data is the twelve months of energy use data immediately preceding the most recent twelve months of energy use data.

24. The computer-readable medium of claim 22, wherein analyzing the energy use data comprises comparing an energy consumption cost of the selected portion of energy use data to an energy consumption cost of the base year of energy use data.

25. The computer-readable medium of claim 21, wherein analyzing the energy use data further comprises applying a linear regression model which uses one or more energy-sensitive variables to at least one of the selected portion of energy use data and the base year of energy use data.

26. The computer-readable medium of claim 25, wherein the one or more energy-sensitive variables comprise weather conditions, occupancy, production level, or a combination thereof.

27. The computer-readable medium of claim 15, further comprising instructions executable by a processor to perform the process steps of:
analyzing the energy use data to determine the need for an energy use reduction for a particular facility; and
sending an alert message to a user if the energy use reduction is needed.

28. The computer-readable medium of claim 15, further comprising instructions executable by a processor to perform the process step of generating signals which cause either a portion of the energy use data or information representing an analysis of the energy use data to be displayed to a user.

29. An energy information management system, the system comprising:
one or more sources of energy use data which generate data signals based upon the energy consumption of one or more facilities; and
a server which is configured to: (i) receive the data signals from the one or more sources of energy use data, (ii) derive energy use data from the data signals, (iii) associate the energy use data with one or more facility types based upon characteristics of the one or more facilities to which the energy use data is related; and (iv) store the energy use data in a database.

30. The energy information management system of claim 29, wherein at least one of the sources of energy use data comprises a utility company network which allows access to information regarding the energy consumption of a facility over approximately monthly periods.

31. The energy information management system of claim 29, wherein at least one of the sources of energy use data comprises a utility meter or shadow meter which periodically measures and records an interval value of the energy consumption of a facility.

32. The energy information management system of claim 29, wherein the server determines which one or more facility types to associate with the energy data based upon at least one of an owner, location, size, age, use, operating schedule, lighting, water use, and heating, ventilation, and air conditioning equipment of the facility to which the energy use data is related.

33. The energy information management system of claim 29, wherein the server is further configured to validate the energy use data by comparing values of the energy use data to one or more expected ranges, wherein the expected ranges are based upon at least one of (i) a facility type associated with the energy use data and (ii) previously stored energy use data in the database.

34. The energy information management system of claim 29, wherein the server is further configured to analyze the energy use data by grouping energy use data associated with a particular facility type or associated with multiple facility types which share a common characteristic.

35. The energy information management system of claim 29, wherein the server is further configured to analyze the energy use data by comparing a selected portion of energy use data related to a particular facility to a base year of energy use data related to the particular facility.

36. The energy information management system of claim 35, wherein the selected portion of energy use data includes at least the most recent month of energy use data.

37. The energy information management system of claim 36, wherein the selected portion of energy use data is the most recent twelve months of energy use data and the base year of energy use data is the twelve months of energy use data immediately preceding the most recent twelve months of energy use data.

38. The energy information management system of claim 36, wherein the server is configured to compare an energy consumption cost of the selected portion of energy use data to an energy consumption cost of the base year of energy use data.

39. The energy information management system of claim 35, wherein the server is further configured to apply a linear regression model which uses one or more energy-sensitive variables to at least one of the selected portion of energy use data and the base year of energy use data.

40. The energy information management system of claim 39, wherein the one or more energy-sensitive variables comprise weather conditions, occupancy, production level, or a combination thereof.

41. The energy information management system of claim 29, further comprising a browser-enabled user device.

42. The energy information management system of claim 41, wherein the server is further configured to generate output signals which cause either a portion of the energy use data or information representing an analysis of the energy use data to be displayed on the browser-enabled user device.

43. The energy information management system of claim 41, wherein the server is further configured to:
analyze the energy use data to determine the need for an energy use reduction for a particular facility; and
send an alert message to the browser-enabled user device if the energy use reduction is needed.

44. The energy information management system of claim 41, wherein the browser-enabled user device is a wireless device.
